(19) United States
(12) Patent Application Publication
(10) Pub. No.: US 2006/0185219 A1
(43) Pub. Date: Aug. 24, 2006

(54) Fishing casting apparatus having a pressure operated launch mechanism

(76) Inventors: Matteo Giordano III, Toms River, NJ (US); George Kennedy, Paramus, NJ (US); Luis Bermudez, Brooklyn, NY (US)

Correspondence Address: JAMES RAY & ASSOCIATES, 2640 PITCAIRN ROAD, MONROEVILLE, PA, 15146, US

(21) Appl. No.: 11/139,113

(22) Filed: May 27, 2005

Related U.S. Application Data
(60) Provisional application No. 60/654,680, filed on Feb. 18, 2005.

(51) Int. Cl. A01K 91/02

(52) U.S. Cl. 43/19

(57) ABSTRACT

An apparatus for casting a fishing line includes an elongated housing with an aperture axially extending therethrough. A fishing reel is attached to the housing adjacent a first end thereof. A telescopic guide is attached to the housing adjacent a second end thereof with each telescopic member receiving the fishing line when such guide is in its extended position. A bobber is coupled to the fishing line and engages the second end of the housing. A bobber launching mechanism includes a first chamber disposed within the aperture adjacent the first end of the hosing and includes a reciprocally mounted piston. A second chamber is disposed adjacent the second end and includes orifice and a seat engaging the orifice. The second chamber is in communication with the first chamber. The reciprocal movement of the piston generates air pressure within second chamber. A release mechanism is disposed intermediate the first and second chambers and is connected to the seat for selective opening and closing of such orifice. Opening of the orifice applies air pressure to the bobber which is launched for engagement with the body of water.

### CROSS-REFERENCE TO RELATED APPLICATIONS

This application is related to and claims priority from U.S. Provisional Patent Application Ser. No. 60/654,680 filed on Feb. 18, 2005.

### FIELD OF THE INVENTION

The present invention relates, in general, to a fishing casting apparatus and, more particularly, the invention relates to a fishing casting apparatus having a pressure operated launch mechanism.

### BACKGROUND OF THE INVENTION

A typical fishing casting apparatus includes a fishing rod and a reel attached to the rod for casting a fishing line through the air that has a floating bobber and a lure or a bait attached to its end. Typically, the user grasps the base of the rod, raises it above his head and snaps his wrist so that the rod swings through the air and the bobber is propelled forward carrying the fishing line with it so that the lure or the bait is launched into the water. The reel is then used to retract the fishing line so the casting can be repeated.

As is generally well known in the field, such swinging motion of the fishing rod and repetitive casting places stress on parts of the human body, such as wrist, hand, and upper body.

Attempts have been made to resolve such problem by utilizing a line casting device assisting the user to launch lure or bait.

U.S. Pat. No. 6,497,066 issued to Harrison and U.S. Pat. No. 5,193,298 issued to O'Neill teach a cartridge with a gas propellant for propelling a projectile from a barrel. However, such cartridge is undesirable due to increased safety concerns.

U.S. Pat. No. 5,735,074 issued to Stauffer and U.S. Pat. No. 5,689,909 issued to Cheney and U.S. Pat. No. 5,421,116 issued to Moon teach line casting assist devices that do not utilize the gas propellant cartridge but which are complex in their construction.

Additionally, U.S. Pat. No. 6,497,066 and U.S. Pat. No. 5,421,116 teach devices that are attached to the fishing rod resulting in difficulties in handling the fishing rod and using such casting assist devices.

Therefore, there is a need for a simple fishing casting apparatus with an assisted launch mechanism that is easy to handle and operate.

### SUMMARY OF THE INVENTION

The invention provides an apparatus for casting a fishing line which includes an elongated housing having a first end and an opposed second end and an aperture axially extending therethrough. A fishing reel is attached to the housing adjacent a first end thereof. A telescopic guide is attached to the housing adjacent a second end thereof with each telescopic member receiving the fishing line when such guide is in its extended position. A bobber is coupled to the fishing line and including a first portion being removably engageable with the second end of the housing and a second portion having a predetermined shape and capable of floating atop a body of water after launch for supporting a portion of the fishing line. A bobber launching mechanism includes a first chamber disposed within the aperture adjacent the first end of the housing and has a reciprocally mounted piston which partially extends through the first end. A directional valve is connected with the first chamber for allowing air flow tehreinto during reciprocal movement of the piston. A second chamber is disposed adjacent the second end and includes an orifice and a seat engaging the orifice. The second chamber is in communication with the first chamber with a flexible line having a passageway. The reciprocal movement of the piston transfers air from the first chamber into the second chamber through the communication line and generates air pressure within second chamber. A release mechanism is disposed intermediate the first and second chambers and includes an elongated member connected to the seat at one end and to the pivotal lever at the other end for selective opening and closing of such orifice. The pivotal lever and the elongated member are biased with a spring for engaging the seat with the orifice. A release actuating button is provided to pivot the lever and disengage the seat from the orifice. Opening of the orifice applies air pressure to the bobber which is launched for engagement with the body of water.

### OBJECTS OF THE INVENTION

It is, therefore, one of the primary objects of the present invention to provide a fishing casting apparatus for launching a fishing line with a lure or bait attached to its end.

Another object of the present invention is to provide a fishing casting apparatus which incorporates a launch assist mechanism.

Yet another object- of the present invention is to provide a fishing casting apparatus with a launch assist mechanism which is simple to operate.

A further object of the present invention is to provide a fishing casting apparatus with a launch assist mechanism that is safe to use.

An additional object of the present invention is to provide fishing casting apparatus with a launch assist mechanism which is easy to handle.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective view of a fishing casting apparatus of the present invention;

FIG. 2 is a partial cross-section view of the fishing casting apparatus along lines 2-2 of FIG. 1; and

FIG. 3 is a partial perspective view of a fishing casting apparatus of the present invention, particularly showing the fishing line guide in a collapsible position.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

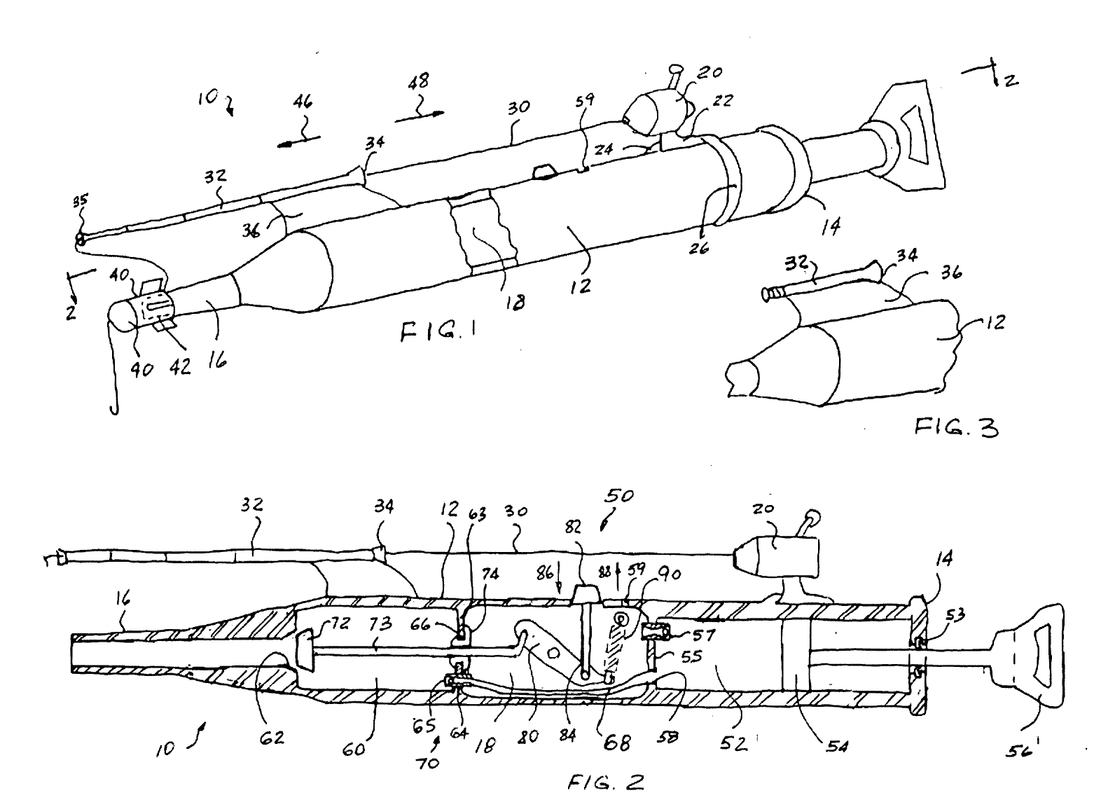

Reference is now made, to FIGS. 1-3, wherein there is shown a fishing casting apparatus, generally designated 10, which has an elongated housing 12 of a predetermined shape and a predetermined length with a first end 14 and an axially opposed second end 16. The first end 14 may be removably attached to the housing 12. An aperture 18 axially extends through the housing 12 intermediate its ends. The preferred shape of the housing 12 is round and a preferred material of the housing elongated 12 is a rigid polymer.

A reel 20 engages the housing 12 adjacent the first end 14 and has a base portion 22 abutting the outer surface of the housing 12 for attachment thereto preferably with a tab 24 outwardly extending from the outer surface of the housing 12 and a locking ring 26 slideable over such base portion 22. The reel 20 holds a predetermined length of a fishing line 30 which extends toward the second end 16 of the housing 12 and passes through a guide means 32 connected to the outer surface of the housing 12 and aligned with the reel 20.

In the preferred embodiment of the present invention, such guide means 32 is formed by a predetermined plurality of hollow telescoping sections which are movable in a first linear direction 46 for extending the guide means 32 and movable in a second direction 48 for collapsing the guide means 32, as best shown in FIG. 3. A base portion 36 is provided for attachment to the outer surface of the housing 12 adjacent the second end 16. Preferably, the ends 34 and 35 of such guide means 32 are outwardly flared to reduce fatigue of the fishing line 30 during use.

Alternatively, such guide means 32 may be a unitary hollow member 32 or a predetermined plurality of well known loop members (not shown) attached to the outer surface of the housing 12 in a predetermined pattern.

The free end of the fishing line 30 is coupled to a bobber 40 which has a first portion 42 adapted for removable engagement with the second end 16 of the housing 12 and a second portion 44 having a predetermined shape for floating atop a body of water (not shown) and supporting a portion of the fishing line 32 adjacent its free end. Preferably, the first portion 42 is a cavity 42 encasing an outer surface of the second end 16.

In a particular reference to FIG. 2, there is means, generally designated 50, at least partially disposed within the aperture 18 of the housing 12 for launching the bobber 40 toward the body of water (not shown) by generating and applying a pressure to the bobber 40 causing thereof to disengage the second end 16 of the housing 12 and launch toward the body of water (not shown).

In the preferred embodiment of the present invention the means 50 includes a first sealed chamber 52 disposed adjacent a first end 14 of the housing 12. A piston means 54 is mounted for reciprocal motion within the first chamber 52 and has a portion thereof extending through the first end 14, such portion has a grip means 56 disposed within or attached thereto. A seal means 53 may be provided for sealing the extension of the piston means 54 through the first end 14.

The first chamber 52 further includes a first directional valve means 57 and a first communication port 58 adjacently disposed in a wall 55 opposite of such first end 14. The first directional valve means 57 is any of the well known directional control valves, allowing air flow in only one direction, which in the present invention, is into the first chamber 52.

Air can be received through a small aperture 59 disposed in the wall of the housing 12 or, alternatively, such first directional valve means 57 may be mounted in the wall of the housing 12.

There is a second sealed chamber 60 disposed adjacent the second end 16 of the housing 12 and spaced from the first chamber 52. The second chamber 60 is adapted with an orifice 62 disposed adjacent the second end 16 and a second communication port 64 disposed oppositely the second end 16 in a wall portion 63. The second communication port 64 is adapted for mounting a second directional control valve 65 allowing air flow in only one direction, which in the present invention, is into the second chamber 60.

The first communication port 58 and the second directional control valve 65 are connected therebetween with a communication means 68 which is preferably a flexible member 68 having a passageway.

A bobber release means, generally designated 70, best shown in FIG. 2, includes a seat means 72 sealably engaging the orifice 62. The seat means 72 is attached to an elongated member 73 which is mounted for reciprocal motion within the second chamber 60 and extend through the aperture 66 of the wall 63. A seal 74 is disposed within the aperture 66 and sealingly abuts such elongated member 73 for sealing the extension thereof through the wall 63 of the second chamber 60.

The distal end of the elongated member 73 is pivotally connected to a first end of the lever 80 which in turn is pivotally connected intermediate its ends to a predetermined portion of the housing 12.

There is a release activation means 82 extending through a wall of the housing 12 and having a portion 84 pivotally connected to the lever 80 adjacent a second end thereof. The release activation means 82 is manually movable in a first direction 86 to launch the bobber 40 and is movable in a second opposite direction 88 by a bias means 90 attached to the second end of the lever 80. In the preferred embodiment, such bias means 90 is a bias spring 90.

In operation, a continuous reciprocal motion of the piston means 54 enable air flow into the first chamber 52 and generates an air pressure which is increasing with each reciprocal motion forcing the air flow into the second chamber 60 through the passageway in the communication means 68. When a predetermined air pressure is generated in the second chamber 60, the release activation means 82 is manually and momentarily moved in the first direction 86 causing the lever 80 to pivot thus displacing the elongated member 73 and disengaging the seat means 72 from the orifice 62 of the second chamber 60. The air pressure in the second chamber 60 is then released through the open orifice 62 and applied to the bobber 40 causing thereof to disengage the second end 16 of the housing 12 and launch forward toward the body of water (not shown).

The bias spring 90 pivots the lever 90 in an opposite direction and reengages the seat means 72 with the orifice 62 thus enabling the apparatus 10 to repeat the launching of the bobber 40 upon reengagement thereof with the second end 16 of the housing 12.

Although the present invention has been shown in terms of the housing 12 having a unitary construction, it will be apparent to those skilled in the art, that the present invention may be applied to the housing 12 formed by a plurality of sections joined together in at least a semi permanent manner. For example, the first section may include the first chamber 52 with the piston means 54 and means for attaching the reel 20, a second section may include the second chamber 60 with the orifice 62, the seats means 72, elongated member 73 and the fishing line guide means 32 and the third section may include the release activation means 82, lever 80, bias spring 90 and communication means 68. Such construction may be advantageous for manufacturing such apparatus 10 and for transporting thereof in confines having a limited space envelope.

Furthermore, the aperture 18 may be formed as a sealed chamber with providing additional means for sealing engagement and movement of the release activation means 82.

Additionally, the first portion 42 of the bobber 40 may outwardly extend from the second portion 44 and be adapted for sliding engagement with the aperture 18 adjacent the second end 16 of the housing 12.

It will be appreciated that the user may hold or support the housing 12 with one hand while pumping air into the chambers and pressing the release activation means 82. For additional convenience of the user, the housing 12 may be provided with ergonomic holding means such as handle disposed in a predetermined portion of the housing 12 or a flexible strap attached to the housing that the user can use to suspend the apparatus from a shoulder or neck body portion.

The fishing casting apparatus of the present invention may be also provided with a storage and carrying case.

The outer surface of at least the housing may be provided in a predetermined color or contain a predetermined indicia.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. An apparatus for casting a fishing line, said apparatus comprising:
(a) an elongated housing having one each of a predetermined shape, a predetermined length and a predetermined material and having a first end and an opposed second end;
(b) an aperture axially extending through said housing;
(c) means engageable with an outer surface of said housing adjacent said first end for mounting a fishing reel;
(d) a guide means engageable with said outer surface of said housing intermediate said first end and said second end thereof for guiding said fishing line;
(e) a bobber coupled to said fishing line and including a first portion being removably engageable with said second end of said housing and a second portion having a predetermined shape and capable of floating atop a body of water for supporting a portion of said fishing line, said bobber launchable under pressure applied thereto for engagement with said body of water;
(f) a bobber launching means at least partially disposed within said aperture for generating and applying said pressure to said bobber, said pressure causing said bobber to disengage said second end of said housing and launch toward said body of water.

2. The apparatus, according to claim 1, wherein said bobber launching means includes:
(a) a first chamber disposed within said aperture adjacent said first end of said housing;
(b) a piston means mounted for reciprocal movement within said first chamber and partially extending through said first end;
(c) a first directional valve means disposed in said first chamber for enabling an air flow thereinto during said reciprocal movement of said piston means;
(d) a second chamber disposed within said aperture adjacent said second end of said housing and spaced from said first chamber;
(e) an orifice having one each of a predetermined shape and a predetermined size and disposed in a first wall of said second chamber adjacent said second end of said housing for open communication therewith;
(f) a second directional valve means disposed in a second wall of said second chamber opposite said second end of said housing for enabling said air flow into said second chamber;
(g) a communication means connected to and in open communication with said first chamber and connected to and in open communication with said second directional valve means for communicating said air flow from said first chamber into said second chamber, said air flow generates a predetermined air pressure within said second chamber; and
(h) a release means disposed within said second chamber and within said housing and engageable with said orifice for selectively opening and closing thereof, whereby opening of said orifice applies said predetermined air pressure to said first portion of said bobber causing thereof to disengage said second end of said housing and launch toward said body of water.

3. The apparatus, according to claim 2, wherein said communication means is a flexible member having a passageway.

4. The apparatus, according to claim 2, wherein said release means includes:
(a) a seat means engageable with said orifice;
(b) an elongated member connected to said orifice at one end and having a second end extending through said second wall of said second chamber, said elongated member mounted for reciprocal motion within said second chamber;
(c) a seal means disposed within said second wall of said second chamber for sealing extension of said elongated member through said second wall;
(d) a lever pivotally connected intermediate a first end and a second end thereof to a predetermined portion of said housing, said first end pivotally connected to said elongated member;
(e) a release activation means pivotally connected to said lever adjacent said second end thereof and partially extending through an outer wall of said housing, said release activation means linearly movable in a first direction and in an opposed second direction, whereby movement of said release activation means in said first direction pivots said lever to move said elongated member and causing said seat means to open said orifice; and
(f) a biasing means connected to said lever adjacent said second end thereof and connected to said housing for biasing said seat means for sealable engagement with said orifice.

5. The apparatus, according to claim 4, wherein said biasing means is a biasing spring.

6. The apparatus, according to claim 1, wherein said apparatus further includes said fishing reel removably attached to said outer surface of said housing by said reel mounting means, said fishing reel containing therein a predetermined length of said fishing line.

7. The apparatus, according to claim 1, wherein said guide means includes a predetermined plurality of hollow telescopic members movable between an extended position and a collapsed position, each receiving said fishing line in said extended position.

8. The apparatus, according to claim 1, wherein said predetermined material of said housing is a rigid polymer.

9. The apparatus, according to claim 1, wherein said apparatus further includes means connected to said housing for suspending said apparatus from a predetermined portion of a human body.

10. The apparatus, according to claim 1, wherein said apparatus further includes a case for storing and carrying said apparatus.

11. The apparatus, according to claim 1, wherein said apparatus further includes a predetermined color applied to at least a portion thereof.

12. The apparatus, according to claim 1, wherein said apparatus further includes a predetermined indicia disposed at least on said outer surface of said housing.

13. An apparatus for casting a fishing line, said apparatus comprising:
(a) a first elongated chamber having a first end and an opposed second end;
(b) a piston means mounted for reciprocal movement within said first elongated chamber and partially extending through said first end;
(c) a first directional valve means disposed in said first elongated chamber for enabling air flow thereinto during said reciprocal movement of said piston means;
(d) means engageable with an outer surface of said first elongated chamber adjacent said first end thereof for mounting a fishing reel;
(i) a second elongated chamber spaced from and connected to said first chamber;
(j) an orifice having one each of a predetermined shape and a predetermined size and disposed in a first end of said second elongated chamber;
(k) a second directional valve means disposed in a second end of said second chamber for enabling air flow into said second elongated chamber;
(l) a communication means connected to and in open communication with said first elongated chamber and connected to and in open communication with said second directional valve means for communicating said air flow from said first elongated chamber into said second elongated chamber, said air flow generates a predetermined air pressure within said second elongated chamber;
(m) a guide means engaging an outer surface of said second elongated chamber and aligned with said reel for guiding said fishing line;
(n) a bobber coupled to said fishing line and including a first portion removably engageable with said first end of said second elongated chamber and a second portion having a predetermined shape, said bobber launchable under pressure applied thereto and said second portion capable of floating atop a body of water for supporting a portion of said fishing line; and
(o) a bobber launching means at least partially disposed within said first end of said second chamber for generating and applying said pressure to said bobber, said pressure causing said bobber to disengage said first end of said second chamber and launch toward said body of water.

14. A guide means for fishing casting apparatus having a fishing pole, a fishing line and a fishing reel attached to said fishing pole and coupled to said fishing line, said guide means comprising:
(a) a predetermined plurality of hollow telescopic members movable between an extended position and a collapsed position, each receiving said fishing line in said extended position; and
(b) means connected to a preselected one of said predetermined plurality of telescopic members for attaching said guide means to said fishing pole.
